(19) United States
(12) Patent Application Publication
(10) Pub. No.: US 2024/0232487 A1
(43) Pub. Date: Jul. 11, 2024

(54) HIGH PERFORMANCE MONTE CARLO CIRCUIT SIMULATION

(71) Applicant: Synopsys, Inc., Sunnyvale, CA (US)

(72) Inventors: Amelia Huimin Shen, Saratoga, CA (US); Horace Ngai Lam, Los Altos, CA (US); Kevin John Kerns, San Jose, CA (US); Minghao Ni, Shanghai (CN)

(21) Appl. No.: 18/406,476

(22) Filed: Jan. 8, 2024

Related U.S. Application Data
(60) Provisional application No. 63/437,823, filed on Jan. 9, 2023.

(51) Int. Cl. G06F 30/3308; G06F 30/327

(52) U.S. Cl. CPC G06F 30/3308; G06F 30/327

(57) ABSTRACT

A computer-implemented method for optimizing a circuit simulator and computing surrogate models using circuit theory-guided machine learning for high performance Monte Carlo simulations. The method may include reading a netlist for performing a Monte Carlo simulation of an electronic circuit, and enabling simulator optimization such that two or more devices sharing one or more device parameters can be combined and simulated as one single optimized device. The method may also include constructing equations of netlist parametric expressions for one or more optimized devices, and computing optimized device mappings.

### CROSS REFERENCE TO RELATED APPLICATIONS

This application claims priority of U.S. Provisional Application No. 63/437,823 titled “HIGH PERFORMANCE MONTE CARLO CIRCUIT SIMULATION,” filed on Jan. 9, 2023, the entire contents of which is incorporated herein by reference.

### TECHNICAL FIELD

The present disclosure relates to an electronic design automation (EDA) system. More specifically, embodiments disclosed herein relate to a system and method for performing Monte Carlo simulation of electronic circuit designs.

### BACKGROUND

Monte Carlo circuit simulation may be used during the design, characterization, and verification of integrated circuit (IC) designs to identify and correct design weaknesses, to improve chip manufacturing yield, and to ensure the chip will meet the operational specifications in the presence of chip variation during the manufacturing process.

A Monte Carlo circuit simulation process may involve randomly generating a set of numbers that are then randomly applied to the equations used to model devices such as metal oxide semiconductor field effect transistors (MOSFETS), transistors, resistors, capacitors, inductors, diodes, etc. Each sample or set of numbers is then simulated and the effect of the random variation is observed on the output of the simulation. Hundreds to millions of samples are simulated in this way to collect distributions that capture the effect of random variation on the outputs of the chip.

Some software approaches may use brute force methods that disable simulation performance optimizations so that all devices in the simulation are uniquely and randomly varied to capture the effect of random variation. This process, however, results in a large increase in the amount of memory needed to simulate and a large degradation in performance, since most optimizations are disabled. As a result, circuits with at most 1.5 million randomly varied devices is approximately the upper limit on netlist size for current Monte Carlo circuit simulations.

### SUMMARY

Some embodiments of the present disclosure described herein cover a method for performing a Monte Carlo simulation of an electronic circuit. The method includes receiving a netlist of the electronic circuit, determining an optimized device based on combining two or more devices sharing one or more device parameters in the netlist of the electronic circuit, and generating a netlist parametric expression for the optimized device. The method further includes generating, random values for the optimized device and updating the netlist parametric expression for the optimized device based on the random values.

Some embodiments of the present disclosure described herein cover a non-transitory computer-readable medium storing program instructions executable by a processing device, causing the processing device to perform operations including reading a netlist of an electronic circuit, and providing simulator optimization such that two or more devices sharing one or more device parameters are combined and simulated as a single optimized device.

Some embodiments of the present disclosure described herein cover a system for performing a Monte Carlo simulation of an electronic circuit. The system includes a processing device, and a memory coupled to the processing device, the memory storing computer readable instructions that when executed by the processing device cause the processing device to perform operations including reading a netlist of the electronic circuit, and enabling simulator optimization such that two or more devices sharing one or more device parameters are combined and simulated as an optimized device. The operations further include generating equations of netlist parametric expressions for the optimized device, mapping devices that share the same netlist parametric expressions, generating random values for each optimized device and computing equations of parametric expressions for each optimized device, and simulating the optimized device using the random values and the equations of parametric expressions.

### BRIEF DESCRIPTION OF THE DRAWINGS

The disclosure may be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example parametric expression tree for computing Monte Carlo variation in a high-performance Monte Carlo simulation, in accordance with an embodiment of the present disclosure.

FIG. 2 illustrates example operations in a computer-implemented method for optimizing a circuit simulator and computing surrogate models using machine learning for high performance Monte Carlo simulations, in accordance with an embodiment of the present disclosure.

FIG. 3A illustrates an example method for optimizing two devices connected in parallel, with the same variation, when the devices have the same instance parameters and all ports have the same connection topology, in accordance with an embodiment of the present disclosure.

FIG. 3B illustrates an example method for optimizing multiple devices in a device stack and applying variation to the optimized device, in accordance with an embodiment of the present disclosure.

FIG. 4A illustrates an example method for optimizing identical blocks that appear multiple times in multiple locations in a circuit design and applying variation to the optimized device, in accordance with an embodiment of the present disclosure.

FIG. 4B illustrates an example method for block-level channel-connect multiplexor variation where devices that touch have unique variations and devices that do not touch share variations, in accordance with an embodiment of the present disclosure.

FIG. 4C illustrates an example method for optimizing a group of cells in a memory array and applying a variation to the optimized group, in accordance with an embodiment of the present disclosure.

FIG. 5 illustrates example operations in the computer-implemented method for optimizing a circuit simulator and computing surrogate models using circuit theory-guided machine learning for high performance Monte Carlo simulations, in accordance with an embodiment of the present disclosure.

FIG. 6 depicts a flowchart of various processes used during the design and manufacture of an integrated circuit in accordance with some embodiments of the present disclosure.

FIG. 7 depicts a diagram of an example computer system in which embodiments of the present disclosure may operate.

### DETAILED DESCRIPTION

Aspects of the present disclosure relate to a system and method for providing high performance Monte Carlo circuit simulation. The methods and systems disclosed herein provide simulator performance optimizations so that the number of devices in the electronic circuit for simulation can be reduced and optimized for simulation efficiency. Random variations are then computed and applied on the optimized devices to accurately capture the effect of random variation on the optimized devices. Different methods may be used to compute the appropriate random variations to be applied for the different types of optimized devices.

According to one embodiment, the method includes determining the type of optimization to be applied to a circuit structure such that one or more of the components of the structure can be randomly varied. The method further includes applying the optimization and recording the optimized nodes and devices that can be subject to variation. The method further includes computing the equations that may be used to generate the variation for the optimized circuit structure and storing on the nodes and devices that may be varied. The method further includes randomly generating a set of numbers for each sample, computing the equations using the random variables, and applying the equations to the components under test.

Some technical advantages of the disclosed system and method are that application of these steps to the circuit simulation allows the simulator to optimize, remove, and merge/change devices, and still retain the equivalent effect of variation in the simulation. Other technical advantages of the present disclosure include, but are not limited to, enabling the optimizations for Monte Carlo simulation results in ten times or more performance and capacity improvements in Monte Carlo simulation. It also enables Monte Carlo simulation for large circuits that could not be simulated using prior methodologies. Additional advantages include that this method also results in Monte Carlo results that are very close or better than a brute force Monte Carlo results in terms of distributions, averages and medians, standard deviations, and confidence intervals. The results of these high-performance Monte Carlo simulations can be used to compute chip yield, to identify potential random variation failures, and to compute standard deviations for the Liberty Variation Format models.

Additional technical advantages include improved computational efficiency, faster processing times, reduced memory and storage requirements, better scalability, increased stability, and lower energy consumption. For example, complexity in simulations often translates to more variables, equations, and interactions to compute. Simplifying the simulation reduces the number of calculations the processor needs to perform, thereby reducing the computational load. This results in faster processing times and more efficient use of computational resources. Additionally, complex simulations can require a large amount of memory to store data about various elements and their interactions. By reducing the complexity, the memory requirement decreases, which can lead to fewer memory bottlenecks and better overall performance, especially on systems with limited RAM. Furthermore, complex simulations can generate large amounts of data that need to be written to or read from storage devices. Simplifying the simulation can reduce the amount of data being generated, thus reducing the I/O overhead and speeding up the simulation. Similarly, complex simulations are more prone to errors and instabilities due to the increased number of interacting components. Reducing complexity can make the simulation more stable and reliable, thereby avoiding computation errors or crashes that can slow down or halt the simulation process. Also, running simpler simulations requires less computational power, which in turn reduces the energy consumption of the computer system. This is particularly important for large-scale simulations running on data centers or supercomputers where energy efficiency is a factor.

The methods and systems disclosed herein achieve the performance and capacity with variation through various techniques, based upon the type of optimization to be applied and the accuracy requirements of the simulation. The disclosed system and method also allows the user to specify which parts of the circuits use the optimized variation techniques as opposed to the brute force techniques, which disable the optimizations.

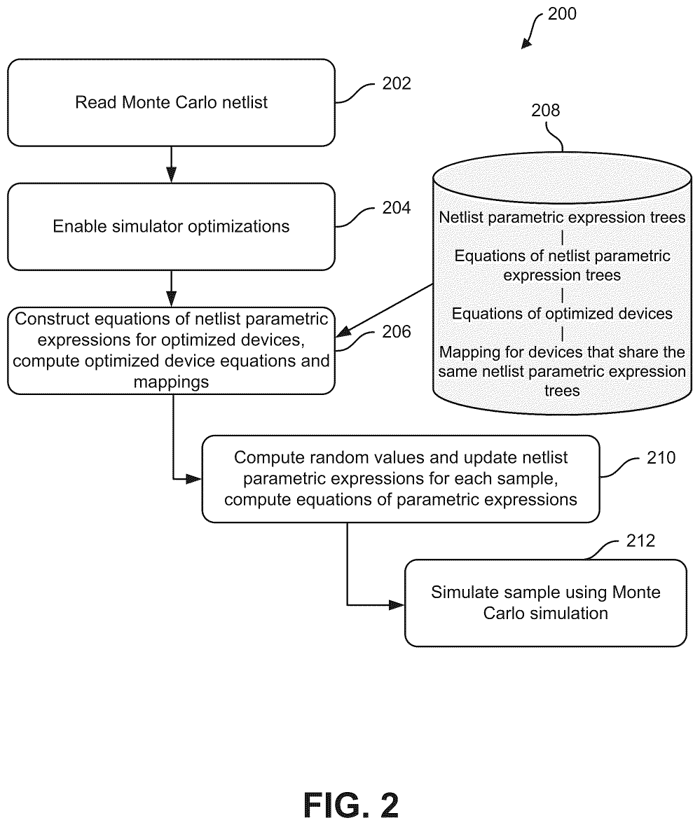

In some embodiments, one or more machine learning (ML) techniques may be used to decide the equations used to apply the variations. In some embodiments, trained ML models may be used to determine which equations to use at 206, which is described below with respect to FIG. 2. One example is a theory-guided machine learning technique to pre-compute domain specific surrogate models for high performance Monte Carlo simulations. Circuit theory equations such as Kirchoff's current law (KCL) and Kirchoff's voltage law (KVL) may be applied to pre-compute a valid random variation model to be applied to the optimized devices. The type of pre-computed or pre-trained ML model used may be determined by the purpose of the Monte Carlo simulation (margin pass/fail, Liberty variation format, high sigma Monte Carlo analysis, yield analysis, etc.), the size of the circuit to be simulated (capacity requirements), and the type of circuit being simulated.

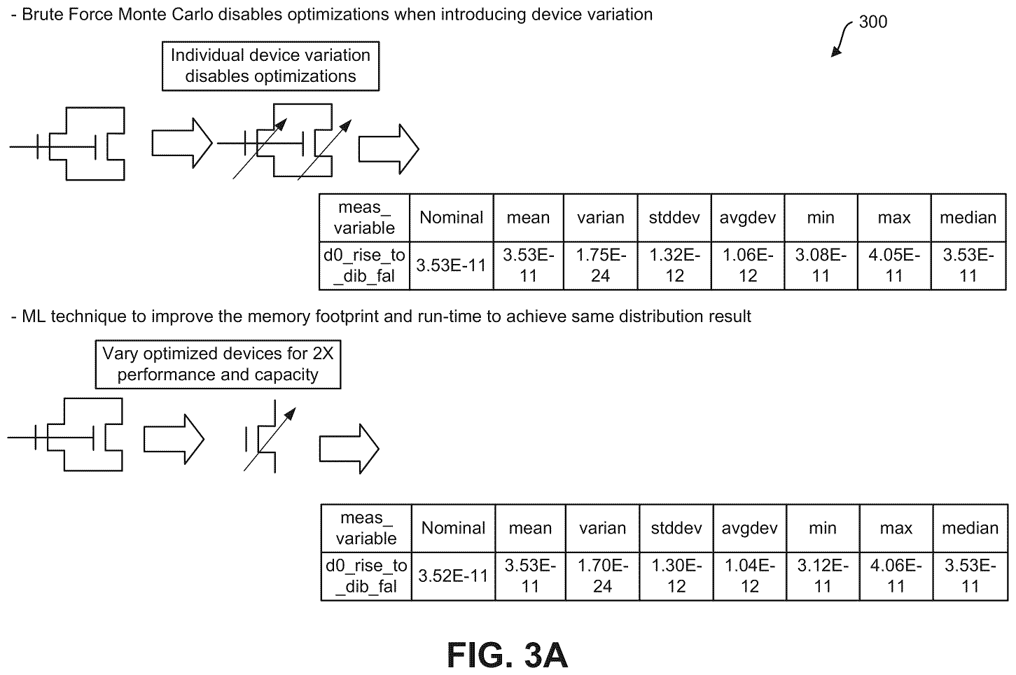

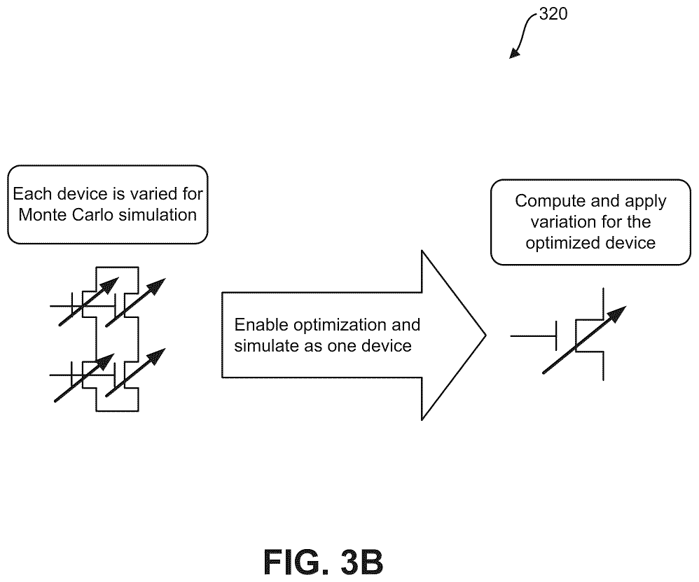

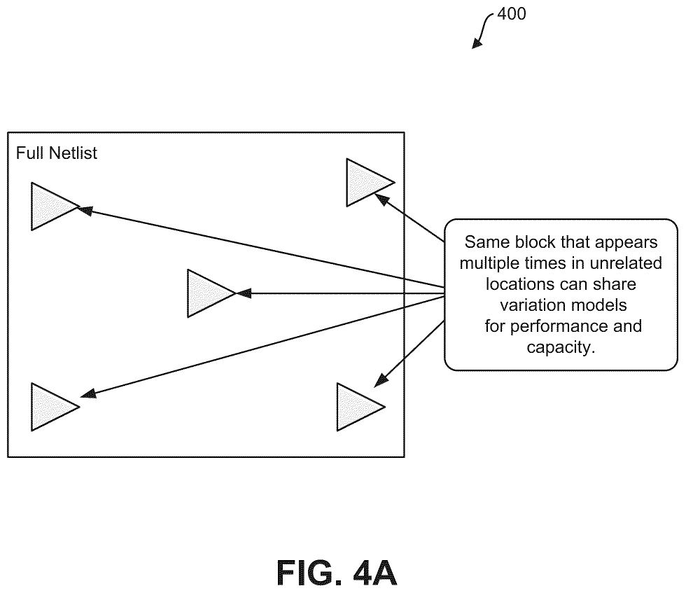

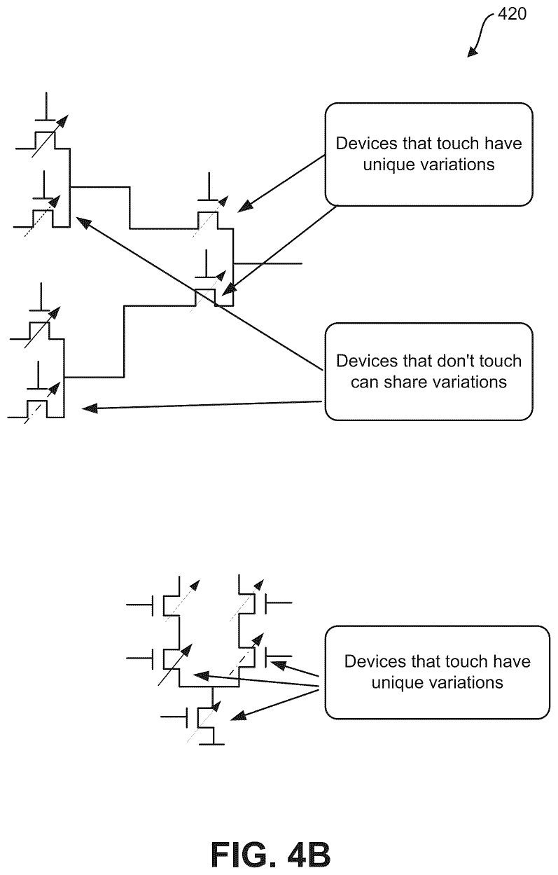

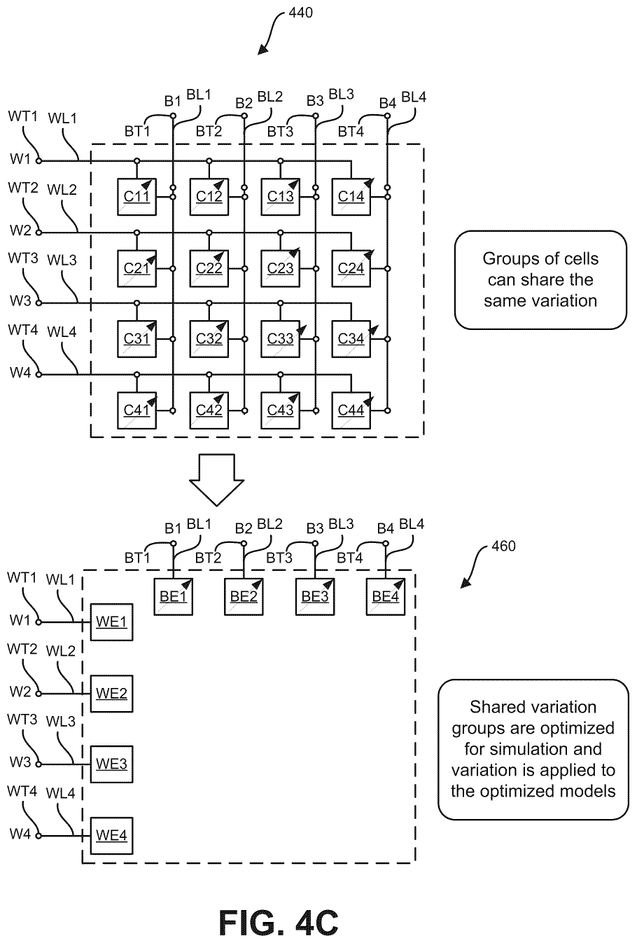

The ML models may be pre-trained for different classes of circuits to determine which kinds of surrogate models to use. Different surrogate models can be applied to different parts of the circuit, based upon the functionality of the circuit. Static random access memory (SRAM) may use one type of surrogate model scheme, and analog circuits such as voltage regulators, operational amplifiers may use a different type of surrogate model scheme. The different types of pre-trained ML models necessary to cover a wide range of circuit types are shown in the optimized variation models illustrated and described in FIGS. 3A-4C.

The KCL and KVL equation computations for the pre-computed optimized models can be stored in a matrix of variation equations that is solved on each sample if the optimized model is large. If the optimized model is small, the computations can be stored as an expression tree. In one example, for each netlist, the simulator may compute the reduced order variation models used for high performance, high capacity (low system memory usage), and accurate Monte Carlo simulations.

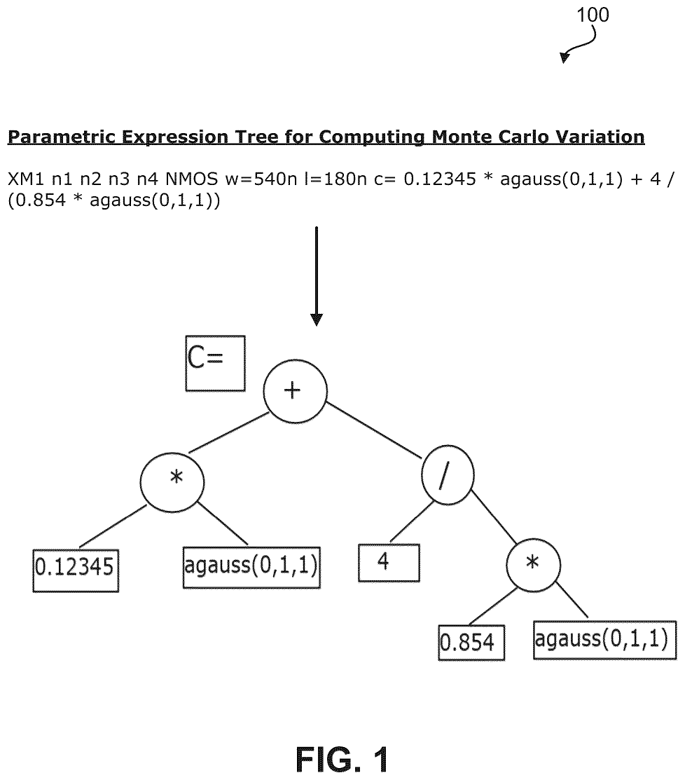

FIG. 1 illustrates an example parametric expression tree 100 for computing Monte Carlo variation in a high-performance Monte Carlo simulation, in accordance with an embodiment of the present disclosure. For example, if the original netlist was as follows for N-type metal-oxide-semiconductors (NMOS) XM1: XM1 n1 n2 n3 n4 NMOS w=540n 1=180n c=′0.12345* agauss(0,1,1)+4/0.854* agauss(0,1,1)′, then it can be illustrated in the form of a parametric expression tree 100 for computing Monte Carlo variation in a high performance Monte Carlo simulation, in accordance with an embodiment of the present disclosure. The netlist parametric expression tree is used to store and update the parameters with randomly generated random numbers for each Monte Carlo sample.

Applying a variation in a Monte Carlo simulation may refer to intentionally introducing changes or uncertainties into the input parameters of a model to assess how these variations affect the outcome. This approach may be used to understand the robustness and reliability of circuits in real-world conditions, where exact values of parameters are often not fixed or precisely known. In some embodiments, key parameters of the circuit are varied randomly within defined ranges. These parameters could be physical properties (like electrical resistance, current, voltage, etc.), or any other factor that influences the circuit's behavior. In some embodiments, the variations may be applied according to statistical distributions (e.g., normal, uniform, log-normal distributions) that represent the likelihood of different values occurring. The outcomes of these numerous simulations are analyzed statistically to understand the probability of different results, identify trends, and assess risks. For example, one might analyze how often the voltage at a certain point exceeds a critical threshold.

FIG. 2 illustrates example operations in the computer-implemented method 200 for optimizing a circuit simulator and computing surrogate models using circuit theory-guided machine learning for high performance Monte Carlo simulations, in accordance with an embodiment of the present disclosure. Method 200 may be performed by one or more processing devices that may include hardware (e.g., circuitry, dedicated logic), software (such as is run on a specialized computer system or a dedicated machine), or a combination of both. Method 200 and each of its individual functions, routines, subroutines, or operations may be performed by one or more processors of the processing device executing the method.

The disclosed method may be used to improve efficiency and accuracy of circuit simulations. The present system and method include combining circuit relationships with machine learning methods. A circuit relationship includes circuit models based on semiconductor physics, circuit behavior, and electronic device operation. These circuit models may be important for accurately simulating how circuits respond under various conditions.

Monte Carlo simulations involve running a large number of simulations with varied input parameters to understand how uncertainties and variations affect the outcomes. This might mean simulating thousands (or even millions) of instances of a circuit with slight variations to understand how circuit design imperfections affect performance.

As described in the paragraphs below, machine learning methods are trained to predict the outcomes of these simulations more efficiently. The training data for these methods is derived from the results of circuit relationship-based simulations. By learning from these data, the machine learning models can predict the results of new simulations much faster than running the full Monte Carlo simulation. The machine learning methods use surrogate models, which are simplified models that approximate the behavior of more complex physics-based models. In this context, the machine learning method acts as a surrogate model. Once trained, it can quickly predict outcomes based on new input parameters, significantly speeding up the simulation process.

In some embodiments, the machine learning models may be guided by the underlying circuit theory. This means that the training process incorporates knowledge from circuit theory to ensure that the machine learning model adheres to the laws and principles of physics, including KCL and KVL. This enhances the accuracy and reliability of the surrogate model. By using these surrogate models, the computational burden of running extensive Monte Carlo simulations is greatly reduced. This leads to faster analysis and iteration times, enabling quicker optimization and validation of various circuits. They allow for more efficient and accurate simulations by combining the robustness of physics-based models with the speed and adaptability of machine learning.

At 202, the processing logic (e.g., a processing device) receives a netlist for performing a Monte Carlo simulation of an electronic circuit. At 204, the processing logic provides simulator optimization such that two or more devices sharing one or more device parameters are combined and simulated as one single optimized device. At 206, the processing logic constructs equations of netlist parametric expressions for one or more optimized devices, and computes optimized device mappings. At 208, the processing logic stores (e.g., in a database) the netlist parametric expression trees, equations of netlist parametric expression trees, equations of optimized devices, and mapping for devices that share the same netlist parametric expression trees. At 210, the processing logic computes random values and updates netlist parametric expressions for each Monte Carlo sample, and computes equations of parametric expressions. In some embodiments, a machine learning model may be used to compute the random values. For example, the machine learning model may use an artificial neural network (ANN), a support vector machine (SVM), a radial basis function (RBF), a fuzzy logic, a decision tree, a random forest, or a k-means algorithm. For every occurrence of the agauss( ) function seen in the parametric expression tree, a random number generator is called to generate a random number. Random numbers may be computed from pseudorandom numbers generated with an initial seed value (integer) given. The initial distribution can be flat between 0 and 1(meaning that all real values between 0 and 1 are equally likely). The flat distribution is then mapped to the desired distribution (e.g., agauss( )). This random number replaces the agauss( ) function in the parametric expression tree, and each parametric expression tree is then evaluated to get a number to assign to that expression. As a result, the netlist parametric expressions are updated with new random numbers.

At 212, the processing logic may simulate the sample using the random values and netlist parametric expressions for each sample and the computed equations of parametric expressions.

For example, if the original netlist was as follows for capacitors C1 and C2: C1 n3 0 C=1e−18* agauss(0,1,1)=> Store as Netlist Expression Tree P1; C2 n3 0 C=2e−18* agauss(0,1,1)=> Store as Netlist Expression Tree P2; then after optimization, the optimized COptimized capacitor can be simulated as follows: Coptimized n3 0 C=3e−18* agauss(0,1,1)=> Store as Equation of Netlist Expression Trees. The equation of netlist parametric expression trees for Coptimized capacitor can be given as: Coptimized n3 0 C=Equation{P1+P2}=> Store as Equation of Netlist Expression Trees P1 and P2.

In another example, if the original netlist was as follows for N-type metal-oxide-semiconductors (NMOS) XM1 and XM2: XM1 n1 n2 n3 n4 NMOS w=540n 1=180n c=′0.12345* agauss(0,1,1)+4/0.854* agauss(0,1,1)′; XM2 n1 n2 n3 n4 NMOS w=540n 1=180n c=′0.12345* agauss(0,1,1)+4/0.854* agauss(0,1,1)′, then after optimization, XMOptimized NMOS can be simulated as follows: XMOptimized n1 n2 n3 n4 NMOS Equation{2*XM1}=> Store as Equation of devices with variation.

The next step involves mapping a table for devices that share the same netlist parametric expression trees. For example, if the original netlist was as follows for N-type metal-oxide-semiconductors (NMOS) XM1, XM100, and XM200: XM1 n1 n2 n3 n4 NMOS w=540n 1=180n c=′0.12345* agauss(0,1,1)+4/0.854* agauss(0,1,1)′; XM100 n101 n102 n103 n104 NMOS w=540n 1=180n c=′0.12345* agauss(0,1,1)+4/0.854* agauss(0,1,1)′; XM200 n201 n202 n203 n204 NMOS w=540n 1=180n c=′0.12345* agauss(0,1,1)+4/0.854* agauss(0,1,1)′; then after mapping, XM100 and XM200 are mapped to XM1, and all 3 MOSFETs may share the same variation, which is NMOS w=540n 1=180n c=′0.12345* agauss(0,1,1)+4/0.854* agauss(0,1,1)′.

The following optimized variation models (e.g., pre-trained ML models) may be used to achieve Monte Carlo distributions that are random and similar to a brute force Monte Carlo simulation distribution. The machine learning models may be guided by the underlying circuit theory. This means that the training process incorporates knowledge from circuit theory to ensure that the machine learning model adheres to the laws and principles of physics, including KCL and KVL. This enhances the accuracy and reliability of the surrogate model. By using these surrogate models, the computational burden of running extensive Monte Carlo simulations is greatly reduced. This leads to faster analysis and iteration times, enabling quicker optimization and validation of various circuits. They also allow for more efficient and accurate simulations by combining the robustness of physics-based models with the speed and adaptability of machine learning.

FIG. 3A illustrates an example method 300 for optimizing two devices connected in parallel, with the same variation, when the devices have the same instance parameters and all ports have the same connection topology, in accordance with an embodiment of the present disclosure. The Brute Force Monte Carlo simulation shown above disables optimization when introducing individual device variation. However, in the disclosed embodiments, two parallel devices can be merged into one device for performance, and the variation is applied to the one device that is two times larger. Series-parallel devices that are merged into one device for performance can also retain the optimization and vary the resulting single device. Similarly, devices that have the same instance parameters and all ports have the same connection topology can share the same variation. The ML technique improves the memory footprint and run-time to achieve the same distribution results by varying optimized devices for 2× or more performance and capacity.

FIG. 3B illustrates an example method 320 for optimizing multiple devices in a device stack and applying variation to the optimized device, in accordance with an embodiment of the present disclosure. Electronic subcircuits including multiple devices and connected in parallel or series-parallel configurations can be optimized via parallel or series-parallel merge, and the compound variation may be computed and applied to the resulting compound optimized device. If certain compound device instances need unique variations, the simulator can apply unique variations to specific instances to achieve Monte Carlo distribution accuracy, nominal performance, and capacity. It should be noted, however, that the optimization is not limited to MOSFETS, and any behavioral source such as a diode, and any other type of element can be series-parallel merged and varied.

FIG. 4A illustrates an example method 400 for optimizing identical blocks that appear multiple times in multiple locations in a circuit design and applying variation to the optimized device, in accordance with an embodiment of the present disclosure. In this method 400, a circuit component, such as a multiplexor or a MOSFET, that appears multiple times in multiple locations can share variation models for performance and capacity. The component can be any type of block, logic gates, multiplexors, amplifiers, etc.

FIG. 4B illustrates another example method 420 for block-level channel-connect multiplexor variation where devices that connect (e.g., in contact) have unique variations and devices that do not connect (e.g., not in contact) share variations, in accordance with an embodiment of the present disclosure. Unconnected devices that share the exact same instance parameters can also share the same variation, instead of making all devices unique and have each device have its own variation. This allows the simulation to continue to share equation models and table models, so the Monte Carlo simulation has similar performance and capacity to the nominal simulation and every device is varied.

For example, the following two devices with the same instance parameters can share a variation: XFE/XM1 n1 n2 n3 n4 NMOS w=540n 1=180n a=0.12345 b=0.9876; and XMIX/XM100 p1 p2 p3 p4 NMOS w=540n 1=180n a=0.12345 b=0.9876. Topological rules may be used to determine if devices are related. For devices that are topologically related, the simulator is able to identify the patterns that should see unique device variations and may apply variations to randomize the topologies.

In some embodiments, the simulator may search all channel connected MOSFETS, bipolar junction transistors (BJTs), junction-gate field-effect transistors (JFETS), diodes, resistors, capacitors, inductors, behavioral voltage and current dependent sources, and apply enough unique variations along the channel connected path to ensure random variation for each channel-connected structure. The rules applied may vary based upon specific configurations such as multiplexors, current mirrors, cascode current mirrors and source coupled pairs, so that devices that touch each other will not share variations, but devices along the same channel connected path that do not touch each other can still share variations. Accordingly, the high performance Monte Carlo simulation can still show random variation distributions on sensitive structures such as amplifiers, bias generation circuits, digital to analog convertors, analog to digital convertors, current mode logic, multiplexed data paths that are critical to correct circuit functionality.

A resistor-capacitor (RC) circuit, or RC filter or RC network, is an electric circuit composed of resistors and capacitors. Linear RC networks can be reduced and replaced with more efficient RC models. The random variation equations are tracked during the reduction process to construct the random variation model to be applied to the optimized RC network. If the RC models all have the same random variation distribution, then that same random variation distribution may be applied to the optimized RC networks.

In one example, the original RC network can have a variation as follows:

R1 n1 n2 R = 10 * agauss(0, 1, 1)
R2 n2 n3 R = 10 * agauss(0, 1, 1)
C1 n3 0 C = 1e—18 * agauss(0, 1, 1)
C2 n3 0 C = 2e—18 * agauss(0, 1, 1)

The optimized RC configuration with variation would be as follows:

R1 n1 n3 R=20* agauss(0,1,1), where R1 and R2 from the original RC network are combined and share a common variation.

C1 n3 0 C=3e−18* agauss(0,1,1), where C1 and C2 from the original RC network are combined and share a common variation.

Here, two different methods may be used for computing and storing the variation for reduced RC networks. One method can be used to reproduce the original RC network Monte Carlo distributions through detailed tracking of the equations to compute the variation for the reduce network on each sample. Using this method, the RC reduction is performed on the nominal RC netlist. All operations used to do the reduction are recorded (e.g., which resistors-were-shorted, nodes-were-reduced, caps-were-lumped, etc. and in what order). During the Monte Carlo simulation, the original RC components can have their values varied according to the netlist specified parameter variations, and the RC reduction can go through the exact same steps as the nominal reduction, but with the updated parameters. This may result in reduced RC networks that are topologically identical to the nominal network and with identical sources of error that do not randomly vary. This approach can handle any type of variation function as well as correlations in values (e.g., all poly resistor vary in the same way). In this method, the computation is stored as a series of matrix or graph operations that represent the optimized RC variation.

Another method is a higher performance method for pass/fail margin analysis and Liberty Variation Format (LVF) computation. Using this method, the individual components are evaluated to convert the values for each RC component into a value pair having mean and standard deviation. RC reduction is then performed on the (nominal) netlist defined using the mean values with no standard deviation variation. The mathematical operations that are performed to calculate the new RC values from individual steps in RC reduction (e.g., resistors shorted, nodes removed, caps lumped, etc.) are enhanced to use the standard deviation of the existing RC to calculate the standard deviations of the newly created RC edges. When all reductions are done, the reduced netlist includes RC components that are specified by mean and standard deviation. At this point Monte Carlo simulations can be performed by varying the reduced RC network directly.

In some embodiments, small resistors with variation below resistor shorting threshold may be shorted. Large resistors with variation above resistor open thresholds are still opened, and small capacitors with variation below minimum capacitor threshold are still opened.

FIG. 4C illustrates an example method (e.g., a first model 440) for optimizing a group of cells in a memory array and applying a variation to the optimized group, in accordance with an embodiment of the present disclosure. Identical cells in the memory arrays (dynamic random access memory (DRAM), static random access memory (SRAM), read-only memory (ROM), and non-volatile memories) can also share the variation so that memory array simulation optimizations can still be applied. In another method (e.g., a second model 460), if certain rows and columns need unique variations, the simulator may apply unique variations to specific active rows and columns, and leave the latent part of the memory array with shared variation, to achieve Monte Carlo accuracy, performance, and capacity.

FIG. 4C shows a flow diagram of a simulation process that incorporates memory array modeling, thereby allowing large memory arrays to be efficiently and accurately modeled. In an initial “PARSE NETLIST” step, the various components and interconnections defined by an input netlist are recognized. Note that various manual or automated techniques may be used to identify memory arrays from netlist. For example, in one embodiment, potential memory cells can be initially identified, after which the organizational structure of those memory cells can be evaluated to determine whether they form a memory array. In another embodiment, memory arrays can be extracted directly from the hierarchy of a hierarchical netlist. Various other techniques will be readily apparent.

The modeling of a memory array involves the generation of a set of equations for the array that tracks the number of memory cells in different cell states (i.e., exhibiting different voltage, current, and optionally, historical voltage and/or current values) and then calculates simulation output values for the memory array based on the distribution of cell states (i.e., the number of memory cells in each cell state). As a result, a mathematical model for each individual memory cell need not be created, which in turn significantly reduces the runtime complexity and memory requirements for the memory array (and hence the IC incorporating the memory array).

Note that from the perspective of the ML engine used, any model for memory arrays generated in in the previous step are simply another black box element in the overall mathematical model. Therefore, the disclosed modeling can significantly reduce the time and memory requirements during the actual circuit simulation without sacrificing simulation accuracy or requiring modifications to the algorithms.

As noted above, the method of generating a ML model involves the generation of a mathematical model for a memory array without defining mathematical models for each individual memory cell. To achieve this result, the modeling technique takes advantage of the highly regular array arrangement of memory arrays and the fact that most memory cells in a memory array are in either a stable logic HIGH or stable logic LOW state at any given time. Specifically, the ML modeling technique replaces the rows and columns of memory cells in a memory array with “boundary elements” that capture the behavior of the memory cells in those rows and columns based on a cell state-based approach, rather than on an individual memory cell modeling approach.

For example, FIG. 4C provides a set of schematic diagrams that conceptually illustrate this modeling concept. A first model 440 for an exemplary memory array includes a rectangular array of memory cells C11 through C44 arranged in a 4×4 array. Each row of memory cells is connected to one of word lines WL1 through WL4, while each column of memory cells is connected to one of bit lines BL1 through BL4. Note that while a small 4×4 array is depicted and described for exemplary purposes, the modeling techniques described herein can be applied to memory arrays of any dimension and any type (e.g., flash memory or content addressable memory (CAM)). In fact, the larger the dimensions of the memory array, the greater the benefit provided by the present technique.

State variable sets W1 through W4 are assigned to word line terminals WT1 through WT4, respectively. Similarly, state variable sets B1 through B4 are assigned to bit lines terminals BT1 through BT4, respectively. Each of state variable sets W1-W4 and B1-B4 includes voltage and current (and optionally, historical voltage and current) variables for its respective bit line or word line. During simulation of the first model 440, the actual values for state variable sets W1-W4 and B1-B4 are either provided as inputs or generated via simulation of memory cells C11 through C44. It is this simulation of individual memory cells that leads to long runtimes and high memory usage during simulation.

The present modeling converts or transforms discrete memory cells C11 through C44 into boundary elements WE1 through WE4 and BE1 through BE4 in a second model 460. Boundary elements WE1 through WE4 are associated with array terminals WT1 through WT4, respectively, of word lines WL1 through WLA, respectively, and boundary elements BE1 through BE4 are associated with array terminals BT1 through BT4, respectively, of bit lines BL1 through BL4, respectively. Each of boundary elements WE1-WE4 and BE1-BE4 tracks the behavior of the memory cells (i.e., memory cells C11 through C44 in the first model 440) connected to the particular word line terminal or bit line terminal associated with that boundary element. Specifically, each boundary element WE1-WE4 and BE1-BE4 recognizes the different cell states exhibited by the memory cells connected to a particular word line or bit line terminal and maintains a count of the number of memory cells in each of those cell states.

For example, boundary element BE1 is associated with array terminal BT1. Therefore, boundary element BE1 tracks the behavior of memory cells C11, C21, C31, and C41, which are all connected to bit line terminal BT1 (bit line BL1). For example, if memory cells C11, C21, and C31 are all in logic HIGH states and memory cell C41 is in a logic LOW state, boundary element BE1 would track two cell states, with three memory cells in the first state (logic HIGH state) and one memory cell in the second state (logic LOW state).

Note that for simplicity, it is assumed that memory cells C11, C21, and C31 are all in stable logic HIGH states (i.e., have been storing logic HIGH values for as many time steps as are needed by the integration method (e.g. one step for Backward Euler and two steps for 2^{nd} order Gear), so that any historical voltage/current values at those cells are all the same). If memory cells C11, C21, and C31 have different historical voltage/current values (e.g., memory cell C21 just finished transitioning to a logic HIGH state, while memory cells C11 and C31 have been at logic HIGH states for at least three clock cycles), boundary element BE1 would simply include an additional cell state for memory cell C21.

In a similar manner, boundary element BE2 tracks the cell states for memory cells C12, C22, C32, and C42, all of which are connected to bit line BL2, boundary element BE3 tracks the cell states for memory cells C13, C23, C33, and C43, all of which are connected to bit line BL3, and boundary element BE4 tracks the cell states for memory cells C14, C24, C34, and C44, all of which are connected to bit line BL4. Likewise, boundary element WE1 tracks the cell states for memory cells C11, C12, C13, and C14, all of which are connected to word line WL1, boundary element WE2 tracks the cell states for memory cells C21, C22, C23, and C24, all of which are connected to word line WL2, boundary element WE3 tracks the cell states for memory cells C31, C32, C33, and C34, all of which are connected to word line WL3, and boundary element WE4 tracks the cell states for memory cells C41, C42, C43, and C44, all of which are connected to word line WL4.

Note that because each boundary element of the second model 460 tracks all the memory cells connected to a particular word line or bit line, the same memory cell may be tracked by multiple boundary elements. For example, because memory cell C11 is connected to both word line WL1 and bit line BL1, memory cell C11 is tracked by both boundary elements WE1 and BE1, respectively. However, as described in greater detail below, because a mathematical model is not generated for each individual cell tracked by a boundary element, this “overlapping” memory cell tracking by multiple boundary elements does not significantly increase simulation runtime or memory requirements.

Note further that for exemplary purposes, the memory array depicted as the first model 440 only includes word lines and bit lines (WL1-WLA and BL1-BL4), and therefore the second model 460 only includes boundary elements associated with the word line and bit line array terminals (WT1-WT4 and BT1-BT4). However, other memory arrays may include additional or alternative array terminals. In each case, boundary elements would then be defined to track the memory cells connected to each of those additional or alternative array terminals. For example, certain memory arrays may include power lines for each row or each column of the array. Boundary elements could then be defined for each of those power lines, with each of those boundary elements tracking the memory cells connected to one of the power lines.

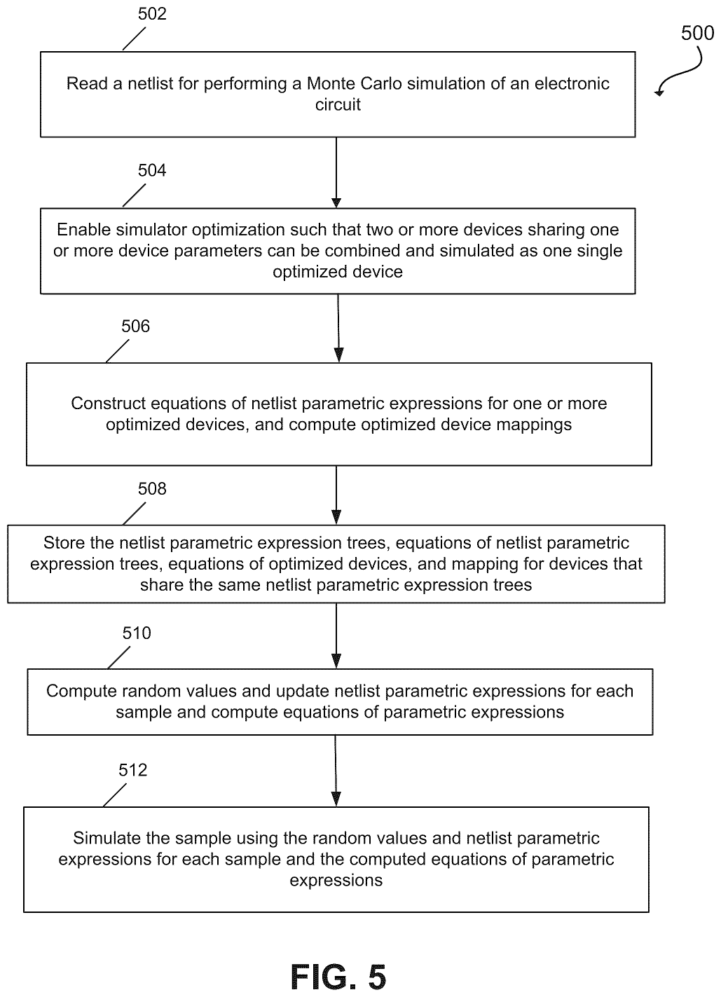

FIG. 5 illustrates example operations in the computer-implemented method 500 for optimizing a circuit simulator and computing surrogate models using circuit theory-guided machine learning for high performance Monte Carlo simulations, in accordance with an embodiment of the present disclosure. Method 500 may be performed by one or more processing devices that may include hardware (e.g., circuitry, dedicated logic), software (such as is run on a specialized computer system or a dedicated machine), or a combination of both. Method 500 and each of its individual functions, routines, subroutines, or operations may be performed by one or more processors of the processing device executing the method.

At 502, the processing logic (e.g., a processing device) receives a netlist for performing a Monte Carlo simulation of an electronic circuit. At 504, the processing logic provides simulator optimization such that two or more devices sharing one or more device parameters can be combined and simulated as one single optimized device. At 506, the processing logic constructs equations of netlist parametric expressions for one or more optimized devices, and compute optimized device mappings. At 508, the processing logic stores (e.g., in a database) the netlist parametric expression trees, equations of netlist parametric expression trees, equations of optimized devices, and mapping for devices that share the same netlist parametric expression trees. At 510, the processing logic computes random values and updates netlist parametric expressions for each sample and compute equations of parametric expressions. In some embodiments, a machine learning model may be used to compute the random values. For example, the machine learning model may use an artificial neural network (ANN), a support vector machine (SVM), a radial basis function (RBF), a fuzzy logic, a decision tree, a random forest, or a k-means algorithm. At 512, the processing logic simulates the sample using the random values and netlist parametric expressions for each sample and the computed equations of parametric expressions.

In some embodiments, reduced-order models may be used for more complex models. Usually, constructing reduced-order models involves dimensionality reduction that attempts to capture the most important dynamical characteristics of often large, high-fidelity simulations and models. One way to do this is to project the governing equations of a system onto a linear subspace of the original state space using a method such as principal components analysis or dynamic mode decomposition.

In some embodiments, machine learning (ML) may be used in constructing reduced-order models for increased accuracy and reduced computational cost. One approach is to build an ML-based surrogate model for full-order models, where the ML model can be considered a reduced-order model. Other ways include building an ML-based surrogate model of an already built reduced-order model by another dimensionality reduction method or building an ML model to mimic the dimensionality reduction mapping from a full-order model to a reduced-order model. ML and reduced-order models can also be combined by using the ML model to learn the residual between a reduced-order model and observational data. ML models can greatly augment the capabilities of reduced-order models because of their quick forward execution speed and ability to leverage data to model high dimensional phenomena.

ML-based reduced-order models can also be used in approximating the dominant modes of the Koopman (or composition) operator, as a method of dimensionality reduction. The Koopman operator is an infinite-dimension linear operator that encodes the temporal evolution of the system state through nonlinear dynamics. This allows linear analysis methods to be applied to nonlinear systems and enables the inference of properties of dynamical systems that are too complex to express using analysis techniques. Although dynamic mode decomposition is a preferred technique for approximating the Koopman operator, other approaches can be adopted to approximate Koopman operator embeddings with deep learning models. Furthermore, adding circuit relationship knowledge to the learning of the Koopman operator can augment generalizability and interpretability. Incorporating principles from circuit relationship-based models could potentially reduce the search space to enable more robust training of reduced-order models, and also allow the model to be trained with less data in many scenarios.

Accordingly, one embodiment is a method for performing a Monte Carlo simulation of an electronic circuit. The method includes reading, by a processing device, a netlist of the electronic circuit. The method further includes enabling, by the processing device, simulator optimization such that two or more devices sharing one or more device parameters are combined and simulated as a single optimized device. The method also includes generating equations of netlist parametric expressions for the optimized device, mapping devices that share the same netlist parametric expression trees, and generating random values for each optimized device and computing equations of parametric expressions. The method further includes simulating the optimized device using the random values and the equations of netlist parametric expressions.

Another embodiment is a non-transitory computer-readable medium storing program instructions executable by a processing device, causing the processing device to perform operations including reading a netlist of the electronic circuit, and enabling simulator optimization such that two or more devices sharing one or more device parameters are combined and simulated as a single optimized device.

Yet another embodiment is a system for performing a Monte Carlo simulation of an electronic circuit. The system includes a processing device, and a memory coupled to the processing device, the memory storing computer readable instructions that when executed by the processing device cause the processing device to perform operations including reading a netlist of the electronic circuit, and enabling simulator optimization such that two or more devices sharing one or more device parameters are combined and simulated as a single optimized device. The processing device further generates equations of netlist parametric expressions for the optimized device, mapping devices that share the same netlist parametric expression trees, and generating random values for each optimized device and computing equations of parametric expressions. In some embodiments, a machine learning model may be used to compute the random values. For example, the machine learning model may use an artificial neural network (ANN), a support vector machine (SVM), a radial basis function (RBF), a fuzzy logic, a decision tree, a random forest, or a k-means algorithm. The processing device further simulates the optimized device using the random values and the equations of netlist parametric expressions.

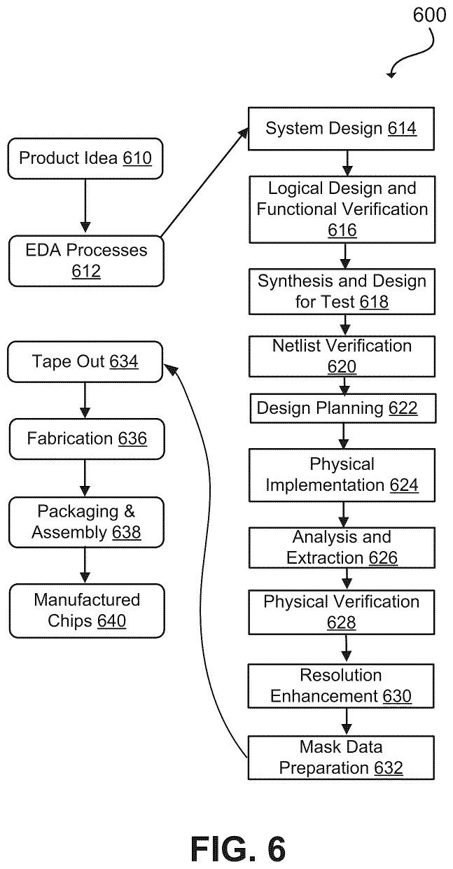

FIG. 6 illustrates an example set of processes 600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes can start with the creation of a product idea 610 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die can be fabricated 636 and packaging and assembly processes 638 can be performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which can be used for detailed descriptions of circuits with many analog components. Descriptions at each level of representation are enabled for use by the corresponding tools of that layer (e.g., a formal verification tool). A design process may use a sequence depicted in FIG. 6. The processes described herein can be enabled by EDA products (or tools).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit can be specified in one or more description languages and the specification can be checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ can be used to speed up the functional verification.

During synthesis and design for test 618, HDL code can be transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist can be checked for compliance with timing constraints and for correspondence with the HDL code. During design planning 622, an overall floor plan for the integrated circuit can be constructed and analyzed for timing and top-level routing.

During layout or physical implementation 624, physical placement (positioning of circuit components such as transistors or capacitors) and routing (connection of the circuit components by multiple conductors) can occur, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flip-flop or latch). As used herein, a circuit ‘block’ may refer to two or more cells. Both a cell and a circuit block can be referred to as a module or component and can be enabled as both physical structures and in simulations. Parameters can be specified for selected cells (based on ‘standard cells’) such as size and made accessible in a database for use by EDA products.

During analysis and extraction 626, which is related to the present disclosure, the circuit function can be verified at the layout level, which permits refinement of the layout design. During physical verification 628, the layout design can be checked to ensure that manufacturing constraints are correct, such as DRC constraints, electrical constraints, lithographic constraints, and that circuitry function matches the HDL design specification. During resolution enhancement 630, the geometry of the layout can be transformed to improve how the circuit design is manufactured.

During tape-out, data can be created to be used (after lithographic enhancements are applied if appropriate) for production of lithography masks. During mask data preparation 632, the ‘tape-out’ data is used to produce lithography masks that are used to produce finished integrated circuits.

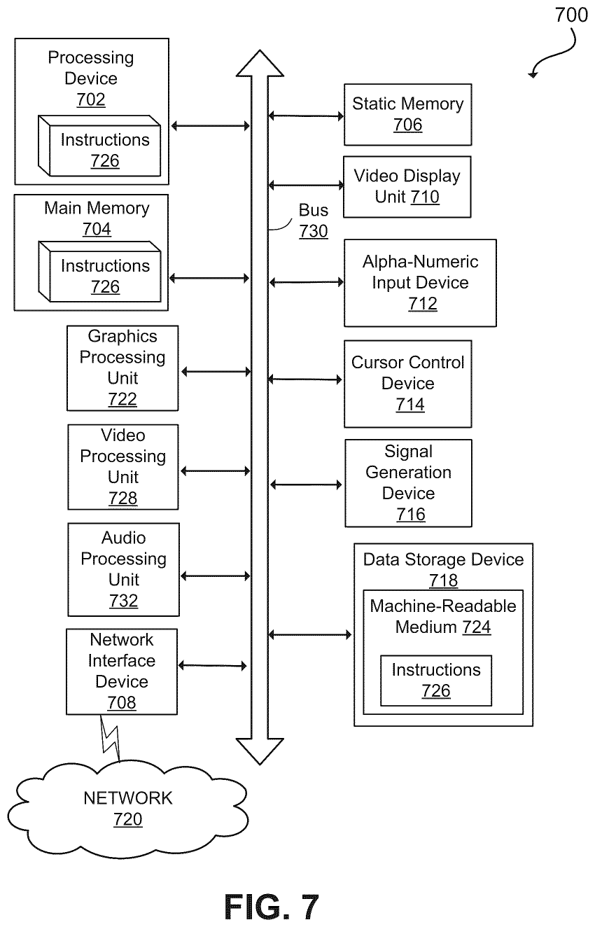

A storage subsystem of a computer system (such as computer system 700 of FIG. 7) may be used to store the programs and data structures that are used by some or all of the EDA products described herein, and products used for development of cells for the library and for physical and logical design that use the library.

FIG. 7 illustrates an example machine of a computer system 700 within which a set of instructions, for causing the machine to perform any one or more of the methodologies discussed herein, including performing noise analysis in an electronic design of an integrated circuit, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one embodiment, the non-transitory computer readable medium may include instructions 726 which when executed by a processing device (e.g., processing device 702), cause the processing device to perform a Monte Carlo simulation as described in FIGS. 1-5. In some embodiments, instructions 726 may include machine learning algorithms that may be trained to predict the outcomes of these simulations more efficiently. The training data for these algorithms may be derived from the results of circuit relationship-based simulations. By learning from these data, the machine learning models can predict the results of new simulations much faster than running the full Monte Carlo simulation. The machine learning algorithms may use surrogate models, which are simplified models that approximate the behavior of more complex physics-based models. In this context, the machine learning algorithm acts as a surrogate model. Once trained, it can quickly predict outcomes based on new input parameters, significantly speeding up the simulation process.

In some embodiments, the machine learning models may be guided by the underlying circuit theory. This means that the training process incorporates knowledge from circuit theory to ensure that the machine learning model adheres to the laws and principles of physics, including KCL and KVL. This enhances the accuracy and reliability of the surrogate model. By using these surrogate models, the computational burden of running extensive Monte Carlo simulations is greatly reduced. This leads to faster analysis and iteration times, enabling quicker optimization and validation of various circuits. They allow for more efficient and accurate simulations by combining the robustness of physics-based models with the speed and adaptability of machine learning.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It may be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It may be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for performing a Monte Carlo simulation of an electronic circuit, the method comprising:
receiving a netlist of the electronic circuit;
determining an optimized device based on combining two or more devices sharing one or more device parameters in the netlist of the electronic circuit;
generating a netlist parametric expression for the optimized device; and
generating, by a processing device, random values for the optimized device and updating the netlist parametric expression for the optimized device based on the random values.

2. The method of claim 1, further comprising:
storing a table that maps the two or more devices to the optimized device.

3. The method of claim 1, further comprising:
simulating the optimized device using the random values and updated netlist parametric expression.

4. The method of claim 1, further comprising:
storing the random values and the updated netlist parametric expression for each optimized device.

5. The method of claim 1, further comprising:
mapping two or more devices in the electronic circuit that share the same netlist parametric expressions to the optimized device.

6. The method of claim 1, further comprising:
computing and applying variation to the optimized device.

7. The method of claim 1, further comprising:
computing and applying the same variation to two or more devices located in two or more locations in the electronic circuit, wherein the two or more devices share one or more device parameters.

8. The method of claim 1, further comprising:
computing and applying unique variations to two or more devices in the electronic circuit that are in contact.

9. The method of claim 1, further comprising:
computing and applying the same variation to two or more devices in the electronic circuit that are not in contact.

10. The method of claim 1, further comprising:
combining a group of memory cells in the electronic circuit to form the optimized device; and
applying a variation to the optimized device.

11. The method of claim 1, wherein generating random values for the optimized device further comprises using a machine learning model comprising at least one of an artificial neural network (ANN), a support vector machine (SVM), a radial basis function (RBF), fuzzy logic, a decision tree, random forest, or k-means algorithm.

12. A non-transitory computer-readable medium storing program instructions executable by a processing device, causing the processing device to perform operations comprising:
reading a netlist of an electronic circuit; and
providing, by the processing device, simulator optimization such that two or more devices sharing one or more device parameters are combined and simulated as a single optimized device.

13. The medium of claim 10, wherein the operations further comprise:
generating a netlist parametric expression for the optimized device; and
generating random values for the optimized device and updating the netlist parametric expression for the optimized device; and
simulating the optimized device using the random values and updated netlist parametric expression.

14. The medium of claim 10, wherein the operations further comprise:
storing a table that maps the two or more devices to the optimized device.

15. The medium of claim 11, wherein the operations further comprise:
storing the random values and the updated netlist parametric expression for each optimized device.

16. The medium of claim 10, wherein the operations further comprise:
mapping two or more devices in the electronic circuit that share the same netlist parametric expressions.

17. The medium of claim 10, wherein the operations further comprise:
computing and applying variation to the optimized device.

18. The medium of claim 10, wherein the operations further comprise:
computing and applying the same variation to two or more devices located in two or more locations in the electronic circuit, wherein the two or more devices share one or more device parameters.

19. The medium of claim 10, wherein the operations further comprise:
computing and applying unique variations to two or more devices in the electronic circuit that are in contact.

20. The medium of claim 10, wherein the operations further comprise:
computing and applying the same variation to two or more devices in the electronic circuit that are not in contact.

21. The medium of claim 10, wherein the operations further comprise:
combining a group of memory cells in the electronic circuit to form the optimized device; and
applying a variation to the optimized device.

22. A system for performing a Monte Carlo simulation of an electronic circuit, the system comprising:
a processing device; and
a memory coupled to the processing device, the memory storing computer readable instructions that when executed by the processing device cause the processing device to perform operations comprising:
reading a netlist of the electronic circuit;
enabling simulator optimization such that two or more devices sharing one or more device parameters are combined and simulated as an optimized device;
generating equations of netlist parametric expressions for the optimized device;
mapping devices that share the same netlist parametric expressions;
generating random values for each optimized device and computing equations of parametric expressions for each optimized device; and
simulating the optimized device using the random values and the equations of parametric expressions.
